(19) United States
(12) Patent Application Publication
(10) Pub. No.: US 2025/0358068 A1
(43) Pub. Date: Nov. 20, 2025

(54) WIRELESS INPUT DEVICE, WIRELESS INPUT SYSTEM AND CONTROL METHOD THEREFOR

(71) Applicant: EMRight Technology Co., Ltd., Hsinchu County (TW)

(72) Inventors: Ming-Hui Chou, Hsinchu County (TW); Ting-Cheng Lai, Hsinchu County (TW)

(73) Assignee: EMRight Technology Co., Ltd., Hsinchu County (TW)

(21) Appl. No.: 19/186,647

(22) Filed: Apr. 23, 2025

(30) Foreign Application Priority Data
May 16, 2024 (TW) 113118120

(51) Int. Cl. H04L 5/00; H04W 72/0446

(52) U.S. Cl. CPC H04L 5/0048; H04L 5/0055; H04W 72/0446

(57) ABSTRACT

A wireless input device, a wireless input system, and a control method thereof are provided. The wireless input device includes a wireless transceiver and a processor. The wireless transceiver communicates with a receiving device through a wireless communication protocol. The processor is coupled to the wireless transceiver. The processor controls the wireless transceiver to: periodically switch the wireless transceiver into a signal transmission state to transmit a pending signal to a specific frequency band corresponding to the wireless communication protocol, wherein a first time interval is defined between the signal transmission states; and periodically switch the wireless transceiver into a listening state to receive incoming signals from the specific frequency band, wherein the operation periods of the signal transmission state and the listening state are mutually separated, and a second time interval is defined between the listening states.

### CROSS-REFERENCE TO RELATED APPLICATION

This application claims the priority benefit of Taiwan application serial no. 113118120, filed on May 16, 2024. The entirety of the above-mentioned patent application is hereby incorporated by reference herein and made a part of this specification.

### BACKGROUND

### Technical Field

This disclosure relates to a control technology for a wireless input device, and more particularly to a wireless input device, a wireless input system, and a control method for the wireless input device.

### Description of Related Art

With advancements in technology, data transmission technologies between computer devices and peripheral devices has gradually evolved from wired transmission to wireless transmission. In many situations, such as when giving a presentation by projecting the screen of a computer device using a projector, controlling the computer device or remotely input information using a presentation pen or a related wireless input device (e.g., a wireless mouse, a wireless keyboard, etc.) is more convenient.

In order for the presentation pen to maintain continuous communication with a remote computer device, the presentation pen performs listening and transmitting information over the frequency band associated with the wireless communication protocol. However, this approach results in increased power consumption of the presentation pen. Since the presentation pen or related input devices are designed to be lightweight and compact, the capacity of the built-in lithium battery in the presentation pen is relatively limited. Therefore, adopting a more power-efficient operating method would help extend the operating time of the presentation pen.

### SUMMARY

The disclosure provides a wireless input device, a wireless input system, and a control method therefor, wherein the wireless input device is periodically switched into a listening state instead of remaining in a constant listening state, thereby reducing the power consumption of the wireless input device.

A wireless input device according to an embodiment of the present invention includes a wireless transceiver and a processor. The wireless transceiver communicates with a receiving device through a wireless communication protocol. The processor is coupled to the wireless transceiver. The processor controls the wireless transceiver to periodically switch the wireless transceiver into a signal transmission state to transmit a pending signal to a specific frequency band corresponding to the wireless communication protocol, wherein a first time interval is defined between the signal transmission states, and, to periodically switch the wireless transceiver into the listening state to receive incoming signals from the specific frequency band, wherein the operation periods of the signal transmission state and operation periods of the listening state are mutually separated, and a second time interval is defined between the listening states.

A wireless input system according to an embodiment of the present invention includes a receiving device and a wireless input device. The receiving device is coupled to a host. The wireless input device communicates with the receiving device through a wireless communication protocol. The wireless input device is configured to periodically enter a signal transmission state to transmit a pending signal to a specific frequency band corresponding to the wireless communication protocol, wherein the signal transmission states being separated by a first time interval, and to periodically enter a listening state to receive incoming signals from the specific frequency band, wherein the listening states being separated by a second time interval, and the signal transmission state and the listening state having non-overlapping operation periods.

In an embodiment of the disclosure, a control method for a wireless input device is provided. The wireless input device communicates with a receiving device through a wireless communication protocol. The control method includes: periodically switching the wireless input device into a signal transmission state to transmit a pending signal to a specific frequency band corresponding to the wireless communication protocol, wherein a first time interval is defined between the signal transmission states, and periodically switching the wireless input device into a listening state to receive incoming signals from the specific frequency band, wherein the operation periods of the signal transmission state and the listening state are mutually separated, and a second time interval is defined between the listening states.

Based on the above, the wireless input device, the wireless input system, and the control method therefor described in the embodiment of the present invention periodically enter a listening state by listening to a specific frequency band corresponding to the wireless communication protocol, with a time interval (e.g., 15 ms) defined between two listening states. On the other hand, the receiving device repeatedly transmits the command in response to the listening state of the wireless input device, until a second feedback signal from the wireless input device is received. In this way, the power consumption of the wireless input device can be reduced without affecting communication between the wireless input device and the receiving device.

### BRIEF DESCRIPTION OF THE DRAWINGS

FIG. 1 is a system block diagram of a wireless input device, a receiving device, and a host according to an embodiment of the disclosure.

FIG. 2 is a schematic diagram of states of a wireless input device according to an embodiment of the disclosure.

FIG. 3 is a schematic diagram of states of a wireless input device and a receiving device according to an embodiment of the disclosure.

FIG. 4 is a flowchart of a control method for a wireless input device according to an embodiment of the disclosure.

### DESCRIPTION OF THE EMBODIMENTS

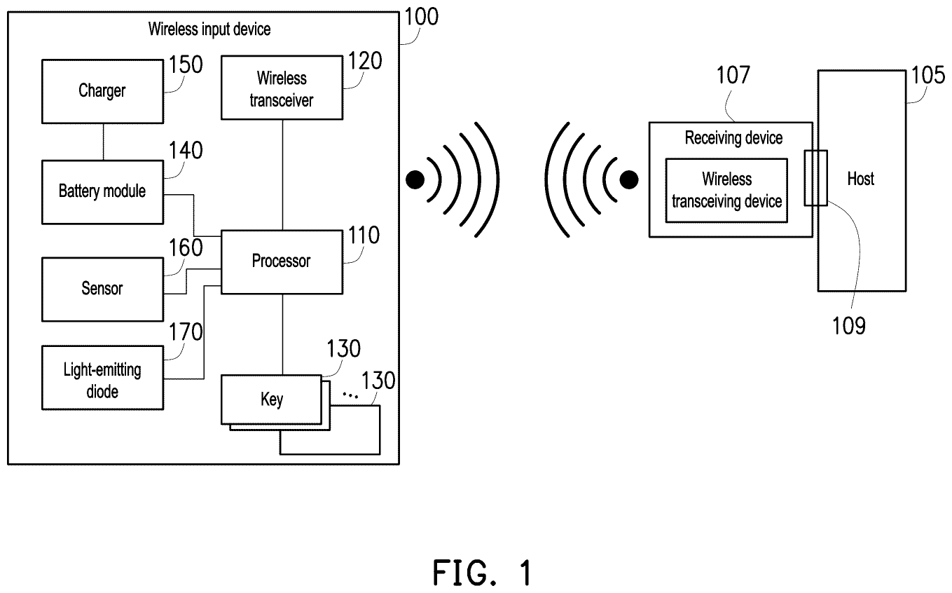

FIG. 1 is a system block diagram of a wireless input device 100, a receiving device 107, and a host 105 according to an embodiment of the disclosure. The wireless input device 100 in this embodiment may be a presentation pen, a wireless mouse, or a corresponding remote input device. The wireless input device 100 and the receiving device 107 may collectively be referred to as a wireless input system.

The receiving device 107, which is paired with the wireless input device 100, is connected to the host 105 through a bus interface 109. The host 105 may be, for example, a laptop computer, a tablet computer, or a computer device connected to a projector, among others. The receiving device 107 may be a wireless communication adapter (dongle) corresponding to the wireless input device 100. The bus interface 109 may be a universal serial bus (USB) interface device, such as a USB 2.0 or USB 3.0 interface device. In this embodiment, the wireless communication between the receiving device 107 and the wireless input device 100 is exemplified using RF 2.4G. However, this embodiment may also be implemented using other wireless communication technologies, such as Wi-Fi or a wireless communication protocol with a specific frequency band. A wireless transceiver device in the receiving device 107 communicates with a wireless transceiver 120 in the wireless input device 100 through the aforementioned wireless communication protocol.

The wireless input device 100 mainly includes a processor 110, the wireless transceiver 120, and a battery module 140. The wireless transceiver 120 communicates with the wireless transceiver device in the receiving device 107 using the same wireless communication protocol. The battery module 140 may be a lithium battery or any other type of battery usable as a power source. The wireless input device 100 in this embodiment is primarily intended to function as a presentation pen or a device for long-term handheld use by a user. Therefore, the battery capacity of the battery module 140 is relatively small.

The wireless input device 100 may further include a plurality of keys 130, a charger 150, a sensor 160, and a light-emitting diode 170. The charger 150 may charge the battery module 140 through an external AC power adapter. The sensor 160 may be an infrared sensor configured to detect whether the user is holding the wireless input device 100, thereby enabling corresponding operations (e.g., causing the wireless input device 100 to enter a power-saving mode, etc.). The light-emitting diode 170 may support multiple colors and is used to indicate the operating state of the wireless input device 100, such as power-saving state, normal operating state, normal remote connection state, connection error state, and so on.

Generally, when the wireless input device 100 and the receiving device 107 communicate with each other, both devices remain in a listening state for extended periods of time in order to receive data, signals, or responses transmitted from each other within the frequency band corresponding to the aforementioned wireless communication protocol. The receiving device 107 has relatively less concerns regarding power consumption, as its power is supplied by the host 105, which typically has a stable power source (e.g., a large-capacity battery or direct power from an AC outlet). In contrast, the wireless input device 100 that remains in a continuous listening state will incur power consumption, whereas the battery module 140 in the wireless input device 100 has a small battery capacity. According to experiments, power consumption in the listening state may account for ⅓ to ½ of the total power consumption of the wireless input device 100.

In the embodiment of the disclosure, power consumption can be reduced by periodically transitioning the wireless input device 100 into a listening state (also referred to as an RX state), with a fixed time interval between two RX states, thereby reducing power consumption. On the other hand, the wireless input device 100 also periodically enters a signal transmission state (also referred to as a TX state), with a fixed time interval between two TX states.

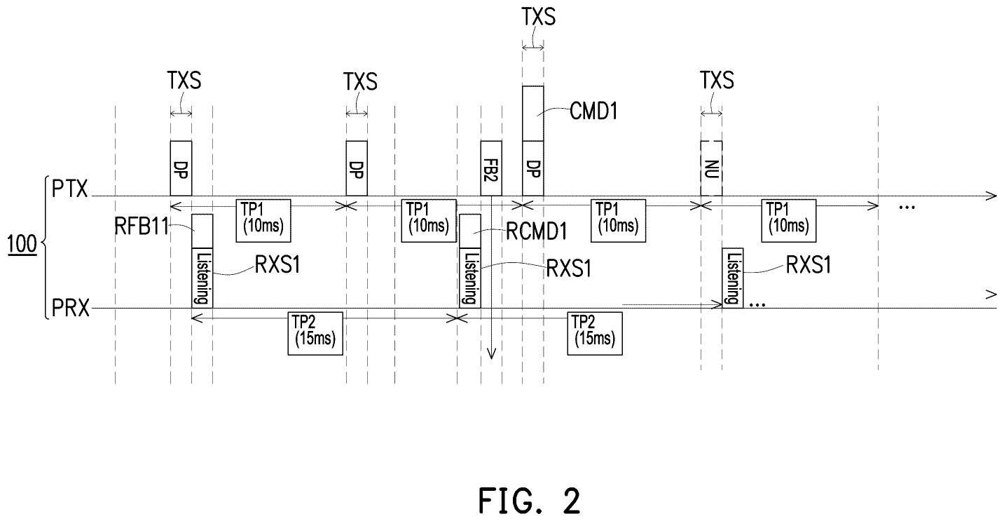

FIG. 2 is a schematic diagram of states of a wireless input device 100 according to an embodiment of the disclosure. In FIG. 2, an arrow representing a TX state of the wireless input device 100 is labeled as a first signal transmission end PTX. The first signal transmission end PTX also corresponds to the operation of a signal transmission end XS in the wireless transceiver 120 of the wireless input device 100 in FIG. 1. In FIG. 2, an arrow indicating an RX state of the wireless input device 100 is labeled as a first signal reception end PRX. The first signal reception end PRX also corresponds to the operation of a signal reception end in the wireless transceiver 120 of the wireless input device 100 in FIG. 1.

In FIG. 2, the processor 110 in FIG. 1 controls and switches the wireless transceiver 120 to periodically cause the first signal transmission end PTX to enter a signal transmission state TXS. In the signal transmission state TXS, the processor 110 in FIG. 1 may transmit a pending signal to a specific frequency band corresponding to the wireless communication protocol through the wireless transceiver 120, so that the receiving device 107 in FIG. 1 can receive the signal. In FIG. 2, a first time interval TP1 is defined between two signal transmission states TXS. In other words, the signal transmission states TXS being separated by the first time interval TP1. In this embodiment, the first time interval TP1 is set to 10 ms. An implementer of this embodiment may adjust the duration of the first time interval TP1 based on requirements, for example, a value between 10 ms and 15 ms may be selected as the first time interval TP1.

In FIG. 2, the processor 110 in FIG. 1 controls and switches the wireless transceiver 120 to periodically cause the first signal reception end PRX to enter a listening state RXS1. In the listening state RXS1, the processor 110 in FIG. 1 may obtain a received signal from a specific frequency band corresponding to the wireless communication protocol through the wireless transceiver 120. The signal transmission state TX S and the listening state RXS1 are temporally separated in operation, i.e., the wireless input device 100 in FIG. 1 does not simultaneously enter the signal transmission state TXS and the listening state RXS1. In other words, the signal transmission state TXS and the listening state RXS1 having non-overlapping operation periods. In FIG. 2, a second time interval TP2 is defined between two listening states RXS1. In this embodiment, the second time interval TP2 is set to 15 ms. An implementer of this embodiment may adjust the second time interval TP2 as needed. For example, selecting a value between 10 ms and 15 ms as the second time interval TP2.

According to experiments, when the second time interval TP2 is set between 10 ms and 15 ms, the power-saving effect of the wireless input device 100 is optimal, reducing power consumption by approximately 39%. If the second time interval TP2 is set above 15 ms, data loss in wireless transmission may occur.

In FIG. 2, the operation period of the signal transmission state TXS and the operation period of the listening state RXS1 are 0.8 ms. The fixed operation periods respectively corresponding to the signal transmission state TXS and the listening state RXS1 of the wireless input device 100 may be different. An implementer of this embodiment may adjust the operation periods of the signal transmission state TX S and the listening state RXS1 independently based on specific requirements. For example, the operation period of the TX state in the wireless input device 100 may be set to 1 ms, and the operation period of the RX state may be set to 0.8 ms.

Since the wireless input device 100 in FIG. 1 enters the signal transmission state TX S periodically, the data to be transmitted to the receiving device 107 within each first time interval TP1 is consolidated into a data packet DP. In this embodiment, the capacity of the data packet DP is designed such that the transmission of the data packet DP can be completed within the operation duration of the signal transmission state TXS (e.g., 0.8 ms). The content of the data packet DP may include signals corresponding to one or more keys 130 in FIG. 1, or signals corresponding to a combination keys (e.g., two keys being pressed simultaneously). The content of the data packet DP may also include cursor coordinate positions, commands issued to the receiving device 107 (e.g., a command CMD1 in FIG. 2), etc.

The wireless transceiver 120 in the wireless input device 100 of FIG. 1 transmits the data packet DP to the receiving device 107 in the signal transmission state TXS and obtains a first feedback signal from the receiving device 107 through the listening state RXS1 (e.g., a listening state RFB11 in FIG. 2). On the other hand, when the wireless transceiver 120 of the wireless input device 100 of FIG. 1 receives a command from the receiving device 107 during the listening state RXS1 (e.g., a command reception state RCMD1 in FIG. 2), the processor 110 of FIG. 1 responds with a second feedback signal FB2 to the receiving device 107 through the wireless transceiver 120 after the command reception state RCMD1.

If, during a certain first time interval TP1, no keys 130 are pressed and no other commands are to be transmitted from the wireless input device 100 of FIG. 1 to the receiving device 107, the wireless input device 100 may refrain from transmitting data in the signal transmission state TXS (e.g., a null data state NU in FIG. 2).

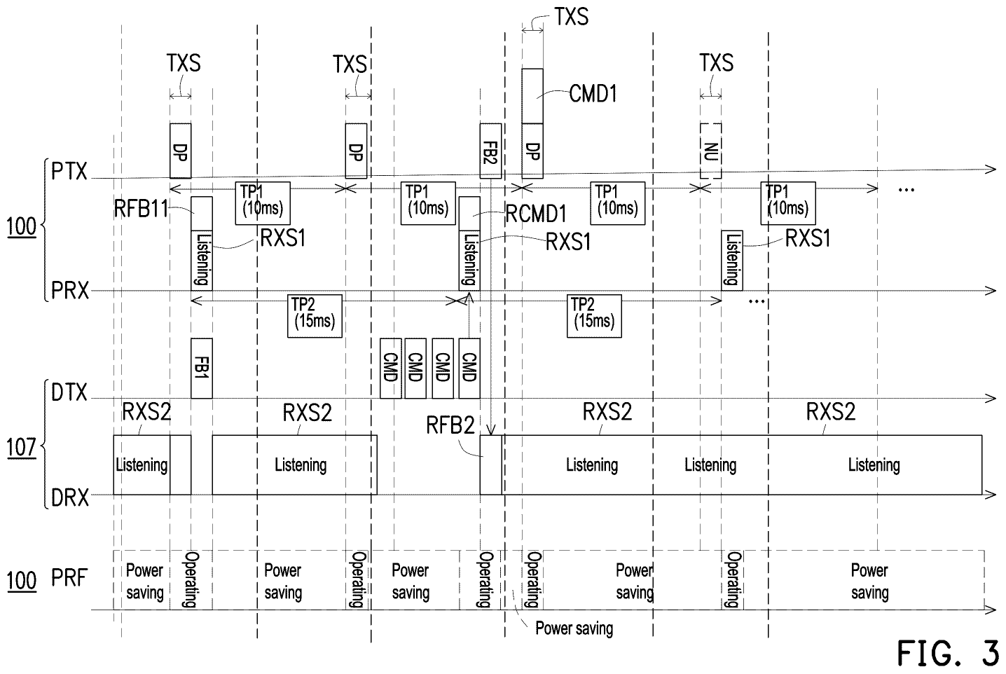

FIG. 3 is a schematic diagram illustrating the states of the wireless input device 100 and the receiving device 107 according to an embodiment of the disclosure. In FIG. 3, an arrow indicating the TX state of the receiving device 107 is denoted as a second signal transmission end DTX. The second signal transmission end DTX corresponds to the operation of a signal transmission end in the wireless transceiver device of the receiving device 107 in FIG. 1. In FIG. 3, an arrow indicating the RX state of the receiving device 107 is denoted as a second signal reception end DRX, which corresponds to the signal reception end of the wireless transceiver device of the receiving device 107 in FIG. 1. The lower portion of FIG. 3 shows the state of the wireless input device 100 of FIG. 1 in a wireless state PRF. The wireless state PRF shows whether the wireless input device 100 of FIG. 1 is in a “power-saving” state or an “operating” state under first to third conditions ST1 to ST3.

This embodiment presents three conditions according to FIG. 3. The first condition ST1 indicates a state in which the wireless input device 100 transmits the aforementioned data packet DP to the receiving device 107. The data in the data packet DP primarily includes corresponding signals of the pressed keys, singals corresponding to combinations of multiple keys, or information such as the coordinate position or displacement of a cursor, etc. In the first condition ST1, the wireless input device 100 enters the signal transmission state TXS to transmit the data packet DP to a specific frequency band of the wireless communication protocol. The receiving device 107 receives the data packet DP at the second signal reception end DRX and transmits a first feedback signal FB1 to the specific frequency band via the second signal transmission end DTX. The wireless input device 100 obtains the first feedback signal FB1 from the receiving device 107 through the listening state RXS1 (e.g., the listening state RFB 11 in FIG. 2).

In the second condition ST2, the receiving device 107 intends to transmit a command CM D to the wireless input device 100. To do so, the receiving device 107 repeatedly transmits the command to the specific frequency band, for example, N times within 15 ms (where N is a positive integer, and in this embodiment, N is set to 4). Furthermore, the receiving device 107 remains in a listening state RXS2. The number of repetitions of the command CM D (i.e., “N”) may be adjusted based on configuration requirements, such as transmitting the command three times or ten times.

If the receiving device 107 does not receive the second feedback signal FB2 from the wireless input device 100 after transmitting the command four times, the receiving device 107 may transmit the command an additional four times after a predetermined period (e.g., 10 ms), thereby attempting to ensure that the wireless input device 100 successfully receives the command.

In the second condition ST2 of FIG. 3, after the wireless transceiver 120 in the wireless input device 100 of FIG. 1 receives a command from the receiving device 107 in the listening state RXS1 (e.g., the command reception state RCMD1 in FIG. 3), the processor 110 in FIG. 1 transmits a second feedback signal FB2 to the receiving device 107 through the wireless transceiver 120. The receiving device 107 subsequently receives the second feedback signal FB2 in the listening state RXS2 (e.g., the listening state RFB2 in FIG. 3).

The third condition ST3 corresponds to a state in which the wireless input device 100 of FIG. 1 has no data to transmit to the receiving device 107. If, during a certain first time interval TP1, none of the keys 130 are pressed and no other commands are to be transmitted from the wireless input device 100 of FIG. 1 to the receiving device 107, the wireless input device 100 of FIG. 1 may refrain from transmitting data in the signal transmission state TXS (e.g., the null data state NU in FIG. 3). At this time, since no data needs to be transmitted in the signal transmission state TXS, the wireless input device 100 of FIG. 1 may disable the wireless transceiver 120 during the signal transmission state TXS, thereby further reducing power consumption.

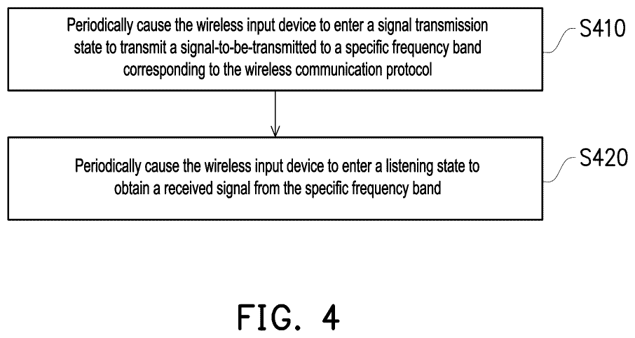

FIG. 4 is a flowchart illustrating a control method for a wireless input device 100 according to an embodiment of the disclosure. The control method shown in FIG. 4 may be applied to the wireless input device 100 in FIG. 1. In step S410, the wireless input device 100 of FIG. 1 is periodically caused to enter a signal transmission state to transmit a signal-to-be-transmitted to a specific frequency band corresponding to a wireless communication protocol. A first time interval is defined between the signal transmission states. In step S420, the wireless input device 100 of FIG. 1 is periodically caused to enter a listening state to obtain a received signal from the specific frequency band. The operating durations of the signal transmission state and the listening state are separated from each other. A second time interval is defined between the listening states. Additional implementation details of the control method in FIG. 4 may refer to the embodiments described above.

In summary, the wireless input device, the wireless input system, and the control method according to the present embodiment periodically perform listening operations on a specific frequency band corresponding to the wireless communication protocol to enter a listening state, wherein a time interval (e.g., 15 ms) is defined between two listening states. On the other hand, the receiving device, iIn response to the listening state of the wireless input device, repeatedly transmits a command multiple times until a second feedback signal transmitted by the wireless input device is received. Accordingly, power consumption of the wireless input device can be reduced without adversely affecting communication between the wireless input device and the receiving device.

What is claimed is:

1. A wireless input device, comprising:
a wireless transceiver, configured to communicate with a receiving device through a wireless communication protocol; and
a processor, coupled to the wireless transceiver,
wherein the processor controls the wireless transceiver to:
periodically switch the wireless transceiver into a signal transmission state to transmit a pending signal to a specific frequency band corresponding to the wireless communication protocol, wherein a first time interval is defined between the signal transmission states; and
periodically switch the wireless transceiver into a listening state to receive incoming signals from the specific frequency band, wherein operation periods of the signal transmission state and operation periods of the listening state are mutually separated, and a second time interval is defined between the listening states.

2. The wireless input device according to claim 1, wherein the wireless transceiver is configured to transmit a data packet to the receiving device in the signal transmission state and to obtain a first feedback signal from the receiving device through the listening state.

3. The wireless input device according to claim 2, further comprising:
at least one key, coupled to the processor,
wherein the at least one key generates a corresponding signal when pressed,
the data packet comprises a signal corresponding to the one or the plurality of keys, and
when none of the at least one key is not pressed, the processor does not transmit a data in the signal transmission state.

4. The wireless input device according to claim 1, wherein after the wireless transceiver receives a command from the receiving device in the listening state, the processor responds with a second feedback signal to the receiving device through the wireless transceiver.

5. The wireless input device according to claim 4, wherein the receiving device repeatedly transmits the command to the specific frequency band N times, and determines whether the second feedback signal from the wireless input device is received, and,
when it is determined that the second feedback signal is not received, the receiving device repeatedly transmits the command to the specific frequency band N times again after a predetermined period.

6. The wireless input device according to claim 1, wherein each of the first time interval and the second time interval is in a range from 10 ms to 15 ms.

7. A wireless input system, comprising:
a receiving device, coupled to a host; and
a wireless input device, communicating with the receiving device through a wireless communication protocol,
wherein the wireless input device is configured to:
periodically enter a signal transmission state to transmit a pending signal to a specific frequency band corresponding to the wireless communication protocol, wherein the signal transmission states being separated by a first time interval; and
periodically enter a listening state to receive incoming signals from the specific frequency band, wherein the listening states being separated by a second time interval, and the signal transmission state and the listening state having non-overlapping operation periods.

8. The wireless input system according to claim 7, wherein the wireless input device transmits a data packet to the receiving device in the signal transmission state and obtains a first feedback signal from the receiving device through the listening state.

9. The wireless input system according to claim 8, wherein the wireless input device further comprises at least one key, wherein the at least one key generates a corresponding signal when pressed, and the data packet includes a signal corresponding to the one or the plurality of keys.

10. The wireless input system according to claim 9, wherein when none of the at least one key is not pressed, the wireless input device does not transmit a data in the signal transmission state.

11. The wireless input system according to claim 7, wherein the receiving device repeatedly transmits a command N times to the specific frequency band corresponding to the wireless communication protocol, and determines whether a second feedback signal from the wireless input device is received, and,
when it is determined that the second feedback signal is not received, the receiving device, after a predetermined period, repeatedly transmits the command N times to the specific frequency band again.

12. The wireless input system according to claim 7, wherein each of the first time interval and the second time interval is in a range from 10 ms to 15 ms.

13. A control method for a wireless input device, wherein the wireless input device communicates with a receiving device through a wireless communication protocol, the control method comprising:
periodically switching the wireless input device into a signal transmission state to transmit a pending signal to a specific frequency band corresponding to the wireless communication protocol, wherein a first time interval is defined between the signal transmission; and
periodically switching the wireless input device into a listening state to receive incoming signals from the specific frequency band, wherein the operation periods of the signal transmission state and the listening state are mutually separated, and a second time interval is defined between the listening states.
